(19) United States
(12) Patent Application Publication
(10) Pub. No.: US 2011/0020577 A1
(43) Pub. Date: Jan. 27, 2011

(54) Label dispensing apparatus, label for use therein and method for dispensing a label

(75) Inventor: David W. Crossley, Charlestown, RI (US)

Correspondence Address: COOPER & DUNHAM, LLP, 30 Rockefeller Plaza, 20th Floor, NEW YORK, NY, 10112, US

(73) Assignee: Applied Results LLC

(21) Appl. No.: 12/460,639

(22) Filed: Jul. 21, 2009

(51) Int. Cl. B65C 9/18

(52) U.S. Cl. 428/41.8; 156/541; 156/230

(57) ABSTRACT

A label dispenser for dispensing a label or the like. A label used in the dispensing apparatus is releasably adhered to a backing material and includes a portion which extends beyond a longitudinal edge of the backing material. The dispenser senses that the extending portion of the label has reached a predetermined position relative to an area where the backing material is peeled away from the label and stops further advancement of the label in the dispenser.

### TECHNICAL FIELD

The present invention relates to a hand-held label dispensing apparatus, a label for use therein and a method for receiving and applying labels to products.

### BACKGROUND OF THE INVENTION

Adhesive labels have long been used to add information to products to which they are adhered. In some cases, the information is embodied in the shape or color of the label. In other cases, information is printed on the label using symbols, letters, or numbers.

Often, a user desires to adhere a number of adhesive labels, each carrying the same information, to a group of similar objects. In these situations, it is often desirable for a user to be able to apply the labels to the group of objects as quickly as possible. One example of such a situation is in a retail store where a clerk may be tasked with applying adhesive price tag labels to a group of like products.

Various means have been proposed to aid in the application of adhesive labels. A typical label dispenser receives a roll of labels of a fixed size affixed to a backing or web with perforations. The perforations in the backing are engaged by an advancing wheel which advances the paper around an edge or roller and peels the backing away from adhesive of the labels effecting a release of the labels from the backing. The distance that the backing is advanced is usually determined by the amount that a lever linked to the advancing wheel is depressed. This type dispenser, however, does not allow a user to easily switch between label shapes or sizes and is configurable only to dispense labels on a roll having a constant size and shape. To switch between label sizes, a complicated calibration process is generally required. Also, the labels must be adhered to the backing in an accurate relationship to the perforations in order to reliably dispense the labels, increasing the cost of manufacture.

Thus, there remains a need for a hand-held label dispenser that enables a user to easily dispense labels of various shapes and sizes without calibration of the dispenser and which is configured to receive readily manufactured label rolls.

### BRIEF SUMMARY OF THE INVENTION

The present invention contemplates a hand-held label dispenser, a label configured for use therein and a method for dispensing labels. The labels of the present invention include tabs located on a side thereof which extend outwardly from a longitudinal edge of the backing material and indicates to a mechanism of the label dispenser a position of the label so that the label dispenser can sense that the label has reached a predetermined position relative to an application area of the dispenser. In the dispenser, a dispensing lever engages an advancing member which moves the backing material around the application area, partially peeling the backing material away from the adhesive side of the labels. When the dispenser senses the tab of an approaching label adhered to the backing material, a lock mechanism is engaged which restricts further movement of the dispensing lever. Once the label is applied and the dispensing lever is released, a biasing member returns the dispensing lever and advancing member to their initial positions.

A motion limiting mechanism may be provided which is configured to be engaged by the lock mechanism when the sensing part senses the presence of the tab in the predetermined position. The motion limiting mechanism allows the advancing member to be moved an extra amount before stopping further motion of the label and backing material.

In a method of the present invention, a label releasably adhered to a backing material is advanced towards an application area of a dispenser, partially separating the label from the backing material. A tab of the label extending outwardly from a longitudinal edge of the backing material is sensed to determine when the tab and the label have reached a predetermined distance relative to the application area. When the label is sensed to be in the predetermined position, further advancement of the label and backing material is stopped.

### BRIEF DESCRIPTION OF THE DRAWINGS

The features of the present application can be more readily understood from the following detailed description with reference to the accompanying drawings wherein:

FIG. 1 is a perspective view of a label in accordance with the present invention.

FIG. 2 is a perspective view of a roll of labels in accordance with the present invention.

FIG. 3 is a top view of alternative labels according to the present invention.

FIG. 4 is a perspective view of the application area of a dispenser according to the present invention.

FIG. 5 is a left side elevational view of a dispenser in an initial position according to the present invention.

FIG. 6 is a detailed left perspective view of a lock mechanism according to the present invention.

FIG. 7 is a right perspective view of a dispenser according to the present invention.

FIG. 8 is a right side elevational view of a dispenser according to the present invention.

FIG. 9 is a left side elevational perspective view of a dispenser in a depressed position according to the present invention.

FIG. 10 is a detailed perspective view of a locking mechanism according to an example of the present invention.

FIG. 11 is a detailed perspective view of a motion limiting mechanism according to the present invention.

FIG. 12 is a flow chart showing a label dispensing method according to the present invention.

FIG. 13 is a flow chart showing an alternative label dispensing method according to the present invention.

### DETAILED DESCRIPTION

The present invention provides a label, a label dispensing apparatus, and a method for dispensing labels.

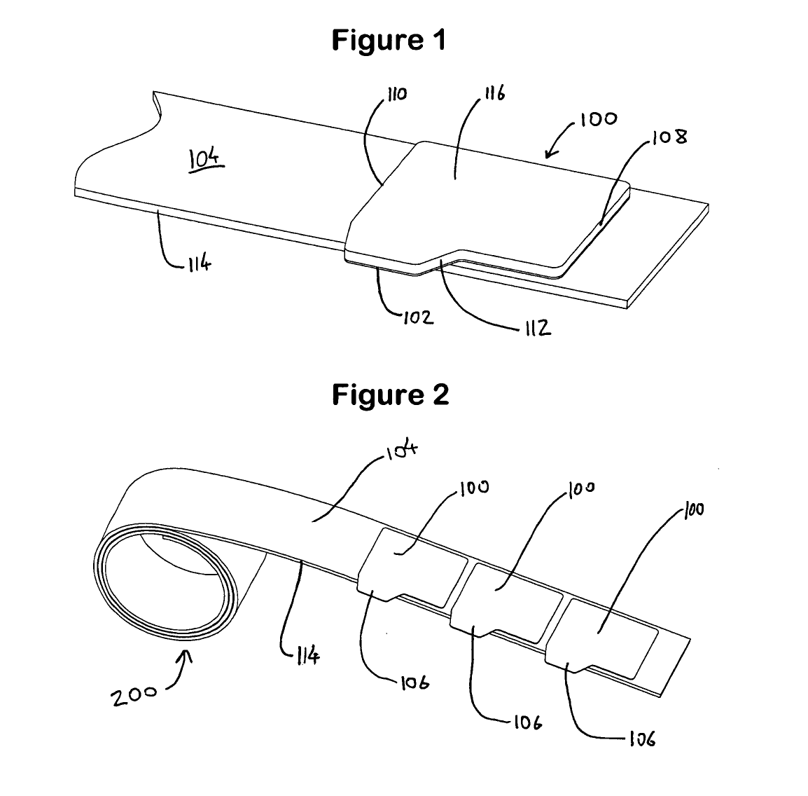

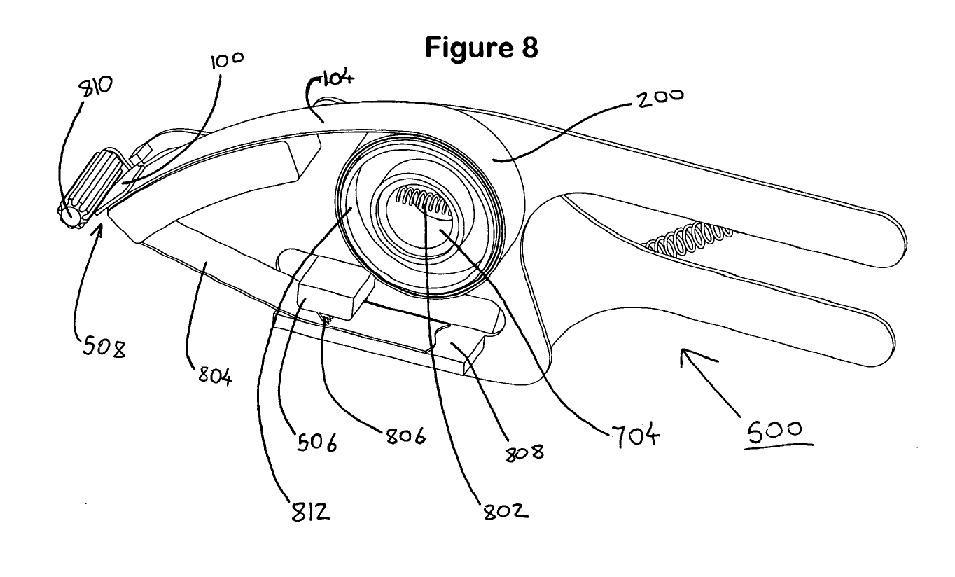

As shown in FIG. 1, a label 100 according to the present invention has adhesive 102 applied to a bottom surface thereof so that it is releasably adhered to a backing or web 104. The backing 104 has a limited amount of adhesion when placed in contact with the labels 100. The labels 100 have tabs 106 which extend outwardly from a longitudinal edge 114 of the backing 104. The tab 106 of the label 100 may be oriented at any point along a length of the label 100. As shown in FIG. 2, a roll of labels 200 according to the invention includes multiple labels 100 on a strip of backing 104 with their tabs 106 aligned on the same side of the backing 104. The strip of labels 100 may be rolled on itself or on a core 812, shown in FIG. 8, to form a roll of labels 200. The core 812 may be aligned with the core 812 and roll 200 in a desired orientation relative to a dispenser 500. The labels 100 may be of any size or shape within a predetermined range. The range is limited only by the size and configuration of the dispenser 500.

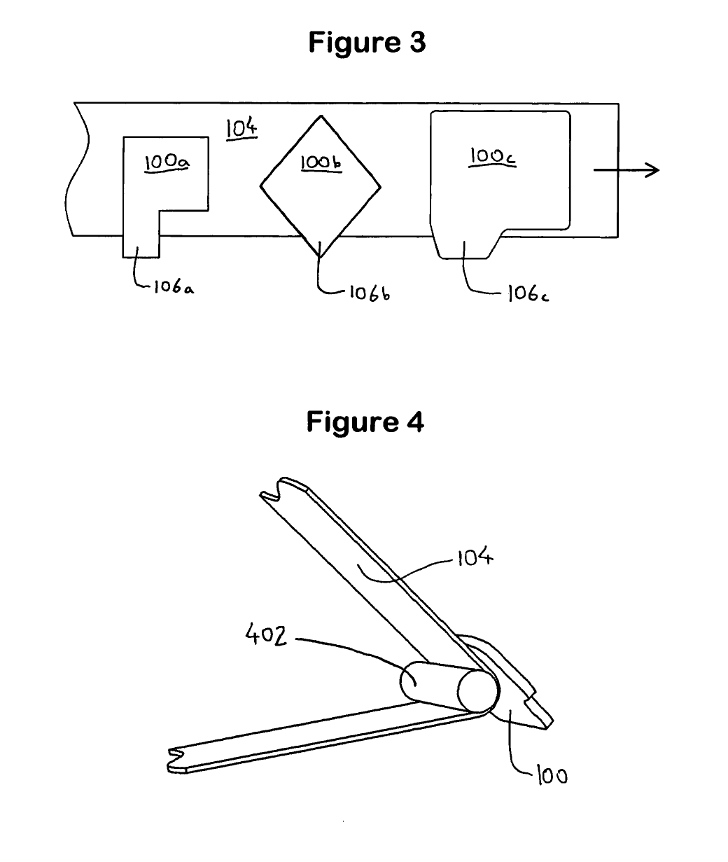

As shown in FIG. 3, each of the labels 100a, 100b and 100c on a strip of backing material 104 need not be of a uniform shape or size. On any roll of labels 200, each label 100 may be a different size, alternating sizes, or provided in a pattern of label types. For example, a roll of labels 200 intended to be used to provide labels 100 for affixing to a loaf of bread in a grocery store may include a price label 100a, a “best by” date label 100b, and a bread type label 100c, in order, followed by repeating groups of similar labels. In this example, each loaf of bread is to receive one each of the three label types. Because the labels 100 are dispensed one after the other by the same dispenser, the user is able to much more efficiently apply the groups of different labels to each of the loaves. The repeating labels 100 may each be, for example, of different shapes, sizes, or colors and may each be printed with different information. The uniform characteristic between all of the labels 100 is the tab 106 extending from the side of the label beyond an edge of the backing material 104 parallel to a longitudinal edge for sensing the position of the label 100.

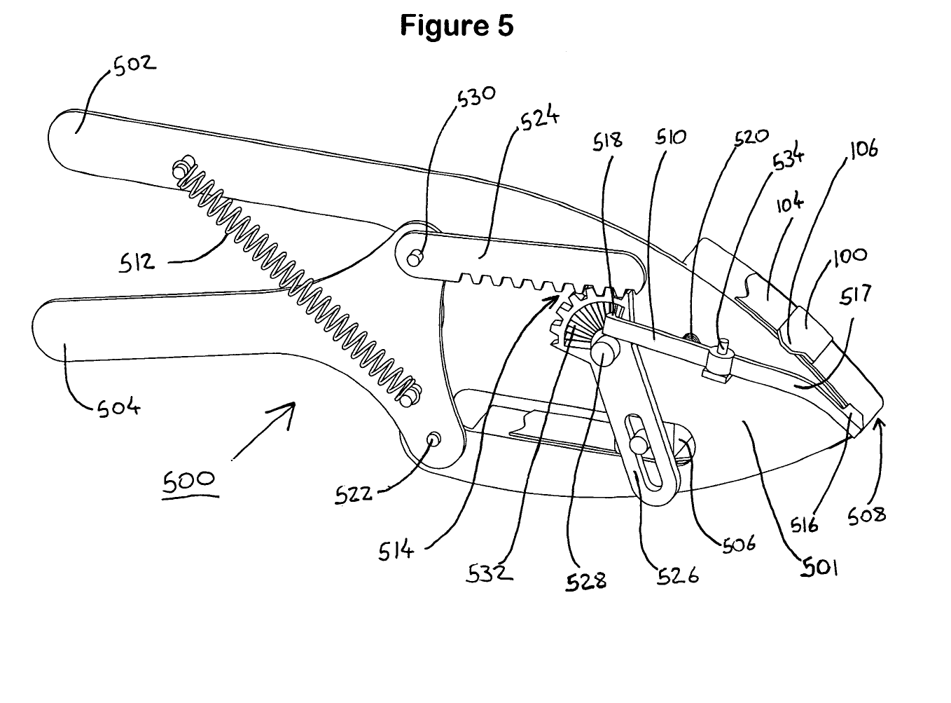

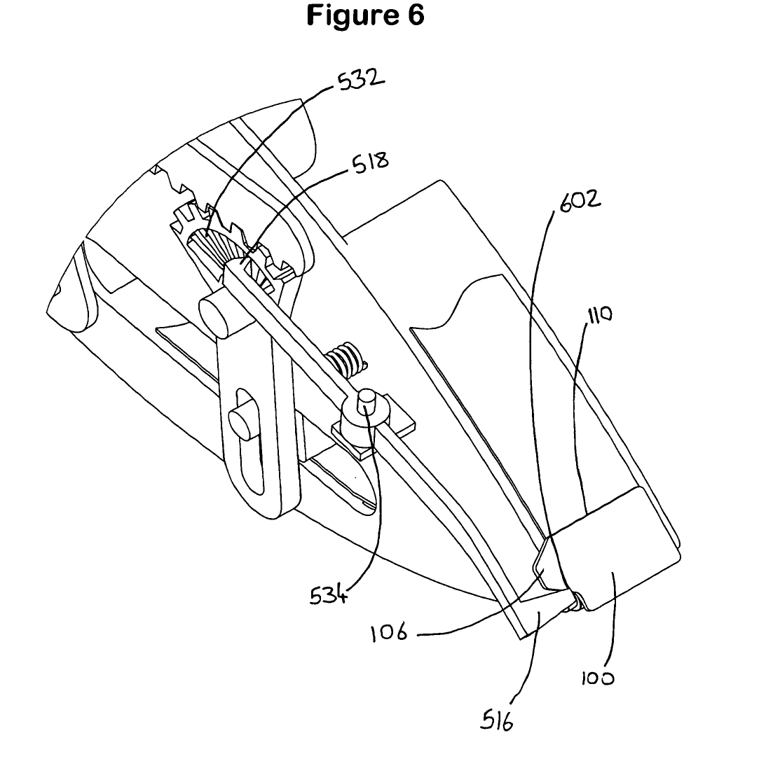

Because the labels 100 are attached to the backing 104 by an adhesive 102 of limited tack, the labels 100 may be easily peeled off of the backing 104 by bending the backing 104 away from the back of the labels. As shown in FIG. 4, the backing 104 may be drawn about the circumference of a cylindrical bending member 402. The cylindrical bending member 402 is rotatable about its axis. Allowing the bending member 402 to rotate reduces the friction between the backing 104 and the bending member 402, reducing the chance that the backing material 104 may suffer a rip or tear as it is moved over the bending member 402. As shown in FIG. 5, bending may also occur as the backing 104 is moved over an application area 508 consisting of an edge formed between two intersecting surfaces.

To facilitate easier separation of the labels 100 from the backing 104, it is desirable that the labels 100 be stiffer with respect to the axis of the bend than the backing 104. If the labels 100 are stiffer than the backing 104, the labels 100 will naturally continue in a direction tangential to their motion towards the application area 508 and will not bend to follow the backing 104 around the bend area 508.

The adhesion strength of the labels 100 to the backing 104 may be controlled, for example, by the selection of the particular adhesive 102 applied to the underside of the labels 100. There are numerous adhesives which are well known in the art that provide different adhesive strengths, among other properties, for a particular environment and for particular adherends. Another way to control the adhesive strength of the label 100 to the backing 104 is to select the surface of the backing 104 to which the label 100 is adhered. For example, the backing 104 may be selected from a materials which do not adhere strongly to the particular adhesive 102 used on the labels 100. The surface of the backing 104 to which the labels 100 are to be adhered may also be finished in a particular fashion to limit the adhesion between the labels 100 and the backing 104. The backing 104 may be highly polished or roughly textured, for example. In another example, a backing substrate may be coated with a material which does not adhere particularly well to the label, such as wax, or a release agent may be used. A minimum amount of adhesion strength is necessary, however, to ensure that the labels 100 do not inadvertently become separated from the backing 104.

As the label 100 is separated from the backing 104 at the application area 508 of the dispenser 500, it is desirable not to completely separate the label 100 from the backing 104 so that the label 100 may be accurately applied to an adherend surface without the risk of misapplication. By holding the backing 104 with the label 100 partially adhered thereto, a user may direct the application of the label 100 by directing the movement of the backing 104. Thus, the amount that the label 100 is separated from the backing 104 and, correspondingly, the adhesion strength of the portion of the label 100 still adhered to the backing 104 are important considerations in the configuration of a label dispenser 500.

As shown in FIG. 5, a dispenser 500 for dispensing the labels 100 of the invention includes a housing 501, a handle 502, a dispensing lever 504, a backing advancing member 506, an application area 508 for peeling the labels 100 off the backing 104, and a lock mechanism 510. When the dispensing layer 504 is squeezed or depressed towards the handle 502 by the user, the dispensing lever 504 causes the backing advancing member 506 to move the backing 104 over the application area 508, partially peeling the label 100 off of the backing 104. The dispensing lever 504 may be provided with a biasing member such as a spring 512 configured to provide resistance to the squeezing action and return the dispensing lever 504 to its initial position once released. Additionally, the motion of the dispensing lever 504 may be connected to the backing advancing member 506 through a motion transmission mechanism 514. Examples of motion transmission mechanisms 514 include linkages rotatably connected to the dispensing lever 504, the backing advancing member 506 and each other, gearing such as round or rack and pinion gears having teeth, and cables connected to the dispensing lever 504 and backing advancing member 506 wound around sheaves or pulleys. Combinations of these mechanisms may also be employed. The lock mechanism 510 includes a sensing finger 516 configured to sense when the tab 106 of the label arrives in a predetermined position relative to the application area 508. The sensing finger 516 of the lock mechanism 510 and the shape of the tab 106 may be coordinated to configure a motion of the sensing finger 516 as it contacts the longitudinal edge of the tab 106. For example, an edge of the tab 106 or sensing finger 616 may be angled to gradually move the sensing finger 516 as the label 100 is advanced. Upon sensing that the tab 106 has arrived in the predetermined position, the lock mechanism 510 causes a lock finger 518 to engage the dispensing lever 504, limiting further movement of the lever 504.

In one example of a lock mechanism 510, the rotation of the dispensing lever 504 about an axis 522 is translated into rotation of a locking wheel having an axis perpendicular to the axis of rotation 522 of the dispensing lever 504 through, for example, a pair of meshing gears or a rack and pinion gear mechanism. The locking wheel is provided with teeth which may be engaged by a locking part having a tooth. The locking finger 518 and sensing finger 516 may be integrally formed at opposite ends of a rocker arm 517 comprising a part of a lock mechanism 510. The rocker arm 517 has an axis of rotation generally parallel to the axis of rotation of the locking wheel. As the sensing finger 516 is contacted and deflected away from the backing 104 by a tab 106 of a label 100, the locking finger 518 is rotated towards and engages the teeth of the locking wheel, limiting further rotation of the locking wheel, and thus limiting further rotation of the dispensing lever 504.

In a different example of a lock mechanism 510, shown in FIG. 5, a ratchet and pawl mechanism is attached to the dispensing lever 504 or a motion transmission mechanism 514 linking the dispensing lever 504 to the advancing member 506. In the example shown in FIG. 5, the motion transmission mechanism 514 comprises a rack 524 rotationally connected to the dispensing lever 504 about an axis 530 and which engages a pinion 526 to transmit motion of the dispensing lever 504 to the backing advancing member 506. The pinion 526 has an axis of rotation 528 parallel with an axis of rotation 522 of the dispensing lever 504 or an axis of rotation 530 of the rack 524 and is provided with a plurality of ratchet teeth 532 arranged in a generally radial arrangement about the axis of rotation 528 of the pinion 526. The locking finger 518 takes the form of a pawl for engagement with the ratchet teeth 532 of the pinion 526. The sensing finger 516 and locking finger 518 are integrally formed on opposite sides of a rocker arm 517 comprising a lock mechanism 510. In this example, the lock mechanism 510 may be configured to rotate about an axis 534 that is oriented generally perpendicular to the axis of rotation 528 of the pinion 526. As the sensing finger 516 contacts the tab 106 of the label 100, the sensing finger 516 is deflected away from the tab 106, thus rotating the lock mechanism 510 about its axis 534. When the sensing finger 516 is rotated away from the tab 106, the locking finger 518 consequently is rotated towards the ratchet teeth 532 of the pinion 526. Because the locking finger 518 may not necessarily line up in between the ratchet teeth 532 of the pinion 526 at the instant that the sensing finger 516 is deflected far enough to rotate the locking finger 518 to engage the toothed surface 532 of the pinion 526, the lock mechanism 510 can be configured to be flexible, allowing the locking finger 518 to remain in contact with the toothed surface 532 of the pinion 526 until it is aligned with and fully engageable with the ratchet teeth 532. The stiffness of the lock mechanism 510, however, should be made low enough so not to cause the sensing finger 516 to deform the tab 106 of the label 100.

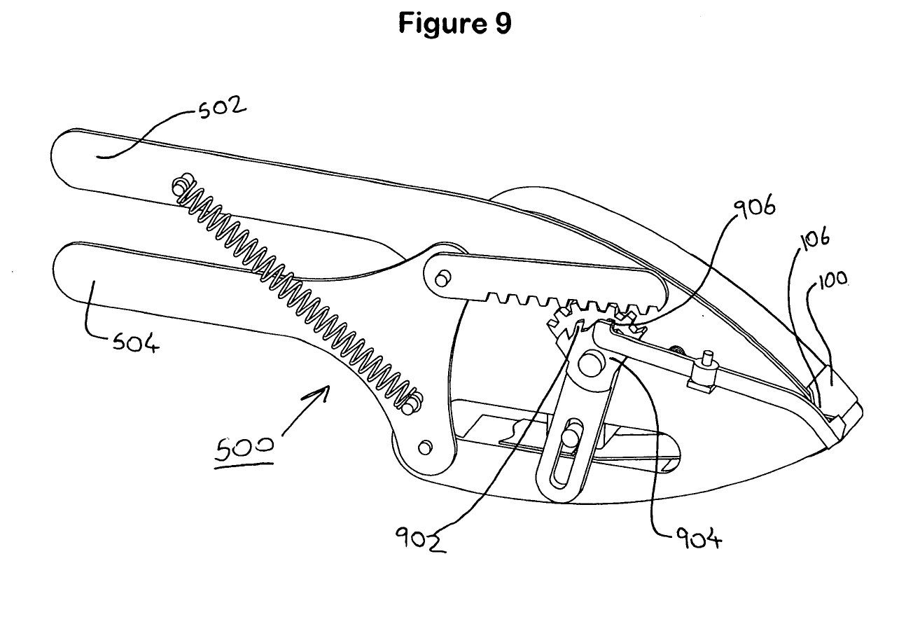

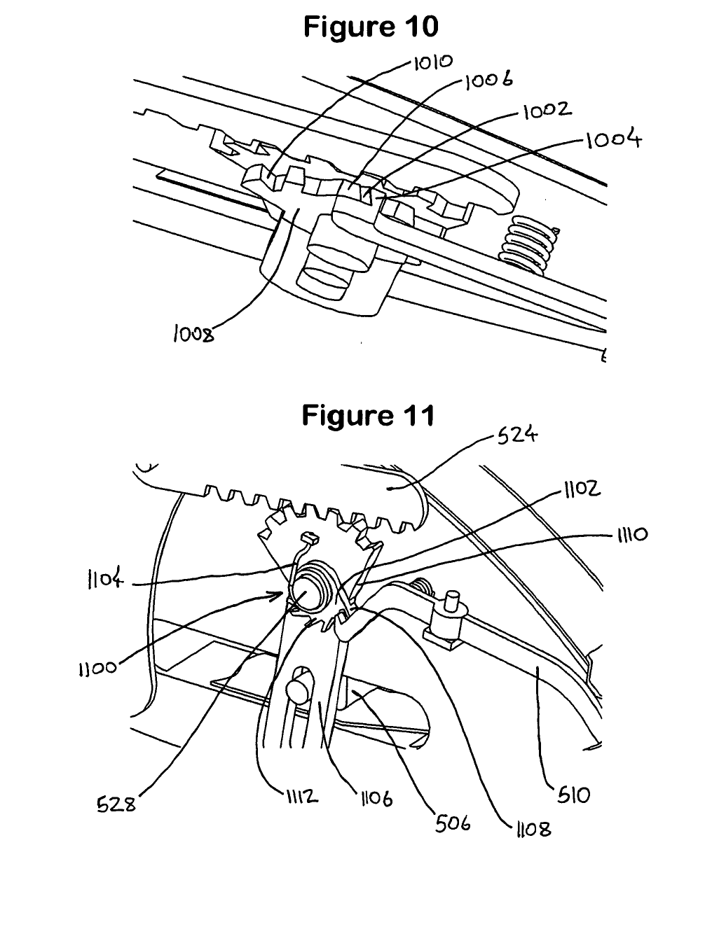

As shown in FIG. 10, in an example of a lock mechanism 510 comprising a pawl 1004, the surface 1002 of the pawl 1004 contacts the teeth 1006 of a ratchet 1008, and the corresponding surfaces 1010 of the teeth 1006 may be undercut surfaces. This provides the added benefit that, if the dispensing lever 504 is depressed until it is locked by the lock mechanism 510 and held in the locked position, the pawl 1004 will not release the teeth 1006 of the ratchet 1008 until both the label 100 is fully separated from the backing 104 and the dispensing handle 504 is released and allowed to return to its initial position. As shown in FIG. 9, the teeth 902 of the ratchet 904 may further be configured to allow the dispensing lever 504 to be released and the ratchet 904 rotated in a return direction even if the pawl 906 is engaged in the teeth 902 and the sensing finger 516 still is in a deflected state caused by the tab 106 of a label 100.

The location of the tab 106 is configured to allow a desired portion of the label 100 to separate from the backing 104 before causing the locking mechanism 510 to lock further movement of the dispensing lever 504. The amount that the label 100 is separated from the backing 104 is determined by the distance from the leading edge of the label 108 along a longitudinal length of the label 100 to the leading edge of the tab 106. FIG. 6 shows a detailed perspective view of a lock mechanism 510 according to the present invention. The effective leading edge of the tab 602 is that point on the tab 106 which, when contacted by the sensing finger 516, first causes the lock mechanism 510 to engage with the dispensing lever 504.

In one example of a sensing finger 516, the sensing finger 516 contacts the leading edge of the tab 602 and deflects in a direction transverse to the longitudinal edge 114 as the backing 104 and label 100 are moved towards the application area 508 by the backing advancing member 506. In this example, it is generally preferable to configure the tabs 106 of different label sizes to be consistent in at least the amount that the tabs 106 extend beyond the longitudinal edge 114 of the backing 104. In another example, the sensing finger may contact the leading edge of the tab 112 and deflect in a direction away from the top surface of the label 116.

When the sensing finger 516 has deflected a predetermined distance, the locking finger 518, which is connected to the sensing finger 516, engages the dispensing lever 504, limiting its further movement. The predetermined deflection distance of the sensing finger 516 is equal to or less than the transverse distance that the tab 106 of the label 100 projects from the longitudinal edge 114 of the backing 104. In the example shown in FIG. 5, the predetermined distance of the sensing finger 516 is configured by setting the distance from the sensing finger 516 to the axis of rotation 534 of the lock mechanism 510, the distance from the axis of rotation 534 of the locking mechanism 510 to the locking finger 518, and the distance that the locking finger 518 is spaced away from an engaged position with the ratchet teeth 532. The lock mechanism 510 may be provided with a biasing member such as a spring 520 to bias the sensing finger 516 towards the backing 104 and labels 100 in a transverse direction or in a direction towards the top surface 116 of the label 100 and biasing the locking finger 518 away from an engaged position.

As shown in FIG. 6, the surface area of the portion of the label 100 still adhered to the backing 104 when the sensing finger 518 reaches the effective leading edge 602 of the tab 106 is determined by the longitudinal distance from the trailing edge 110 of the label 100 to the effective leading edge 602 of the tab 106. As discussed above, the adhesion strength between the portion of the label 100 still adhered to the backing 104 is determined not only by the surface area of the portion of the label 100 still adhered to the backing 104, but also by the composition of the adhesive 102 applied to the label 100 and the properties of the backing 104. Thus, the location of the effective leading edge 602 of the tab 106 relative to the leading edge 108 and trailing edge 110 of the label 100 as well as the composition of the adhesive 102 and backing 104 are factors influencing the dispensing of labels 100 using the dispenser 500 of the present invention.

The tabs 106 of the labels 100 need not be consistent in shape or placement relative to the body of the label 100. Similarly, the adhesive 102 used on the labels 100 need not be consistent, especially when different shapes or types of labels 100 are provided on a common backing 104 or on different rolls of labels 200 configured to be received by the same dispenser 500. For example, the effective leading edge 602 of a tab 106 of a relatively large label 100 having a relatively strong adhesive 102 may be placed further towards the trailing edge 110 than the effective leading edge 602 of a tab 106 on a relatively small label 100 having weaker adhesive 102. The configuration of each label 100, including the adhesive 102 used, the size and shape of the label 100 and the location of the tab 106, is customizable.

The overall width of the labels 100 is also customizable. Because the tabs 106 of the various labels 100 are all configured to extend from the same longitudinal edge 114 of the backing 104, the width of the labels 100 is not dependent upon the interaction of the tabs 106 with the sensing finger 516.

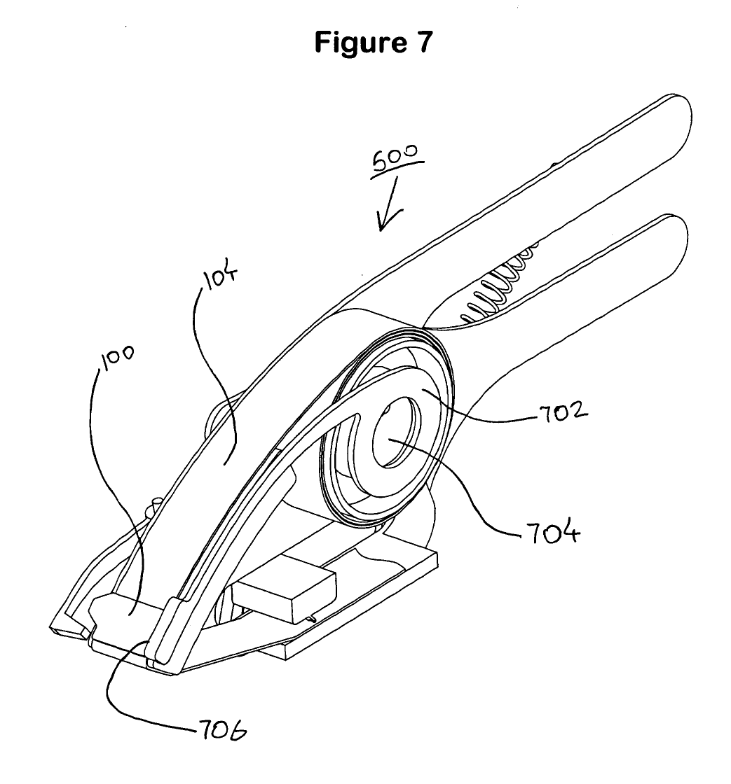

To aid in proper tracking of the labels 100 and backing 104 about the application area 508, a guiding member 702 is provided which guides the backing 104 and labels 100 towards the sensing finger 516. As shown in FIG. 7, the guiding member 702 may be installed over a spindle 704 projecting from the housing 501 or a component fixed to the housing 501. In another example, the guiding member 702 may include a projection which engages the housing 501 or a component fixed to the housing 501. The guiding member 702 also includes a guiding surface 706 which is configured to aid in the tracking of the labels 100 and backing 104 near the application area 508. The added tracking guidance provided by the guiding surface 706 helps to ensure that the backing 104 is not dislodged from its position in the dispenser 500 when a user adheres a separated portion of a label 100 to an object and moves the dispenser 500 away from the object to fully separate the label 100 from the backing 104.

The guiding surface 706 also prevents the backing 104 from travelling in an unintended direction as the backing advancing member 506 is actuated by the dispensing lever 504. If the backing 104 is wide or the advancing member 506 is located to one side of the longitudinal edge 114 of the backing 104, the backing advancing member 506 provides an off center moving force which tends to cause an unintended motion of the backing 104 as it moves about the application area 508. Such an unintended motion, if not prevented, may cause the sensing finger 516 to sense the tabs 106 of the labels 100 improperly or may cause a rip in the backing 104.

When applying a label 100 to an object or product, during the final separation of the label 100 from the backing 104, the adhesion of the label 100 to the backing 104 has a tendency to pull the backing 104 away from the dispenser 500, the backing 104 staying adhered to the label 100. To prevent such an occurrence, the dispenser 500 may include a roll tensioning device 802, as shown in FIG. 8. The roll tensioning device 802 provides a resistance force necessary to overcome in order to rotate the roll of labels 200. The resistance force is configured to be greater than the pulling force exerted by the portion of the label 100 still adhered to the backing 104 as it is fully separated from the backing 104. One example of a roll tensioning device 802 is a spring distorting the shape of spindle 704 over which a roll of labels 200 is placed, providing a resistance to the roll 200 rotating about the spindle 704. On the other side of the application area 508, the advancing member 506 or another grip mechanism may hold the already separated portion 804 of the backing 104 fixed relative to the dispenser 500 to prevent the backing 104 from pulling away from the dispenser 500 during the application of a label 100.

In one example of a backing advancing member 506, teeth 806 are alternately engaged in linear grooves of a plate which extends in the direction of motion of the backing advancing member 506. The backing 104 is fed through a slight gap between the teeth 806 and the grooves before using the dispenser 500. In another example, teeth 806 of the backing advancing member 506 are spaced a slight distance away from a flat plate 808. When actuated by the dispensing lever 504, the teeth 806 of the backing advancing member 506 engage the backing 104, digging into the backing 104 or perforating it slightly. Once engaged, the teeth 806 of the backing advancing member 506 move the backing 104 away from the application area 508, partially separating the label 100 from the backing 104, and drawing more backing 104 and labels 100 from the roll 200. Once the dispensing lever 504 is locked by the locking mechanism 510, the backing advancing member 506 is held in place while the user applies the label 100 to the object. Once the label 100 is applied, the user releases the lever 504, allowing the backing advancing member 506 to disengage from the backing 104 and return to its initial position. The teeth 806 may be angled to point towards the direction of movement of the backing 104 to better engage the backing 104 on the advancing stroke, while allowing for easier disengagement of the backing 104 at the beginning of the return stroke.

In another example of an advancing member 506, a wheel whose outer circumferential surface compresses the backing 104 against another wheel or a fixed surface is caused to rotate by the movement of the dispensing lever 504. The engagement between the dispensing lever 504 and the advancement wheel is configured to transmit motion only in the advancing direction and not in the return direction. Such a configuration may be accomplished, for example, with the employment of a ratchet and pawl system.

The dispenser 500 may also include a label applicator 810, as shown in FIG. 8. The label applicator 810 may be a wheel or cylinder formed of a compliant material and located in front of the application area 508 and adjacent to the top surface 116 of the label 100 once the label 100 is partially separated from the backing 104. When the dispensing lever 504 is depressed until the sensing finger 516 senses the tab 106 and causes the lock mechanism 510 to lock further movement of the dispensing lever 504, the user may apply downward pressure with the label applicator 810 on the label 100 as it is brought into contact with the object. If the label applicator 810 is configured to rotate about an axis parallel to the surface of the object, the user may roll the label applicator 810 over the top surface 116 of the label 100, compressing the label 100 against the object and improving the adhesion of the label 100 to the object.

The dispenser 500 may also be provided with a motion limiting mechanism 1100 as shown in FIG. 11. For example, the locking finger 518 of the lock mechanism 510 may engage with the motion limiting mechanism 1100 which, once the locking finger 518 is engaged, limits further movement of the dispensing lever 504 or motion transmission mechanism 514 attached thereto to a predetermined extra amount rather than immediately locking the dispensing lever 504 from further movement. This extra amount of movement allowed in the dispensing lever 504 translates into an extra distance that the advancing member 506 moves the backing 104 before further motion is stopped. In one example of a motion limiting mechanism 1100, a ratchet 1102 is locked by a locking finger 518 of the lock mechanism 510, as described above, and the ratchet 1102 is engaged though a torsion spring 1104 to an advancing linkage 1106 which connects the dispensing lever 504, rack 524 and the backing advancing member 506. The ratchet 1106 is further provided with a rotation stop 1108 which contacts a surface 1110 of the advancing linkage 1106 to limit the amount of compression of the torsion spring 1104 that is possible. In such a motion limiting mechanism 1100, the dispensing lever 504 is depressed, moving a rack 524 engaged with the advancing linkage 1106, rotating the advancing linkage 1106 about its axis 528. The torsion spring 1104 translates the rotation of the advancing linkage 1106 to the rotation of the ratchet 1102 mounted on the same axis 528 as the advancing linkage 1106. The advancing linkage 1106 moves the backing advancement member 506 until the sensing finger 516 of the locking mechanism 510 senses the effective leading edge 602 of the tab 106 on a label 100. Then, the locking finger 518 of the locking mechanism 510 engages the teeth 1112 of the ratchet 1102, stopping further rotation of the ratchet 1102. The dispensing handle 504 still is able to be depressed an extra amount, compressing the torsion spring 1104 between the advancing linkage 1106 and the ratchet 1102 until the rotation stop 1108 on the ratchet 1106 contacts the surface 1110 of the advancing linkage 1106. At this point, no further depression of the dispensing lever 504 is allowed.

The shapes and sizes of the tabs 106 of the labels 100 may be different. The tabs 106 of the labels 100 may be configured to anticipate the extra movement distance of the backing 104 created by a motion limiting mechanism 1100. For example, the tabs 106 may have a longitudinal dimension greater than, equal to, or less than the extra movement distance. If the tabs 106 have a longitudinal dimension greater than the extra movement distance, the sensing finger 516 of the lock mechanism 510 will remain in contact with the side of the tab 106 even after the backing 104 is moved the extra distance by the backing advancing member 506, thus still engaging the lock mechanism 510 until the label 100 is applied to an object.

If the tab 106 has a longitudinal dimension equal to or less than the extra movement distance, the sensing finger 516 will detect the trailing edge of the tab 106 as the backing advancing member 506 advances the backing 104 the extra movement distance. When the trailing edge of the tab 106 is sensed, the lock mechanism 510 will disengage from the ratchet 1102, allowing the dispensing handle 504 to be fully depressed and the label 100 completely separated from the backing 104. Such a feature may be useful in allowing the user to dispose of an unwanted label 100 without touching the label 100 with his or her fingers. For example, the torsion spring 1104 of the motion limiting mechanism 1100 may provide a greater resistance to the depression of the dispensing lever 504 once the ratchet 1102 is engaged by the locking finger 518, than a biasing member 512 opposing depression of the dispensing lever 504 in relation to the handle 502. In such a configuration, the user would first feel the smaller resistance of the biasing member 512 until the effective leading edge 602 of the tab 106 reaches the sensing part 516. Then, the user will feel the larger resistance of the torsion spring 1104 as the motion limiting mechanism 1000 is compressed and the tab 106 is advanced past the sensing finger 516. Once the trailing edge of the tab 106 is advanced past the sensing finger 516, the user will again feel the light resistance of the biasing member 512, as the lock mechanism 510 will have disengaged the motion limiting member 1100. Thus, in this configuration, the user is able to sense when a label 100 has been advanced to a predetermined position by feeling the resistance to the relative motion of the dispensing lever 504 to the handle 502. The predetermined position may be the ideal separation amount of the label 100 from the backing 104 for application of the label 100 to an object. When the user encounters the stronger resistance of the torsion spring 1104, he or she may apply the label 100 to an object. The user may also continue depressing the dispensing lever 504 past the period of high resistance to fully separate the label 100 from the backing 104, if desired.

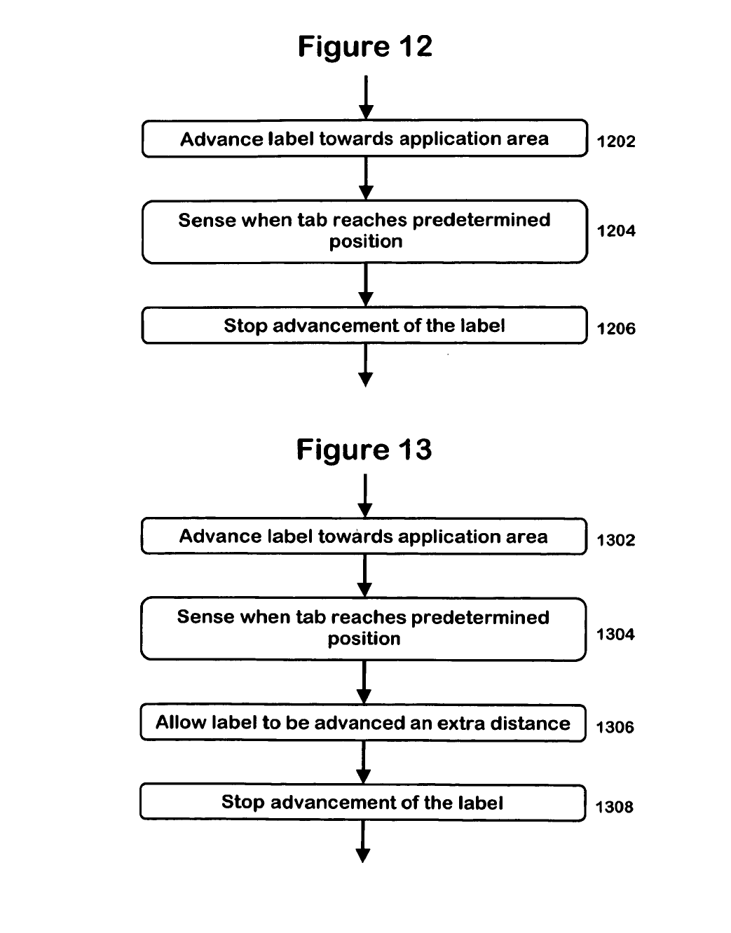

A label dispensing method according to an example of the present invention is shown in FIG. 12. The method for dispensing a label 100 includes depressing a dispensing lever 504 to advance 1202 a label 100 including a tab 106 extending beyond a longitudinal edge 114 of a backing 104 to which the label 100 is adhered, drawing the backing 104 over an application area 508 and bending the backing 104 away from the adhesive 102 of the label 100. Next, the tab 106 is sensed 1204 by a sensing finger 516 when the tab 106 reaches a predetermined position relative to the application area 508. When the sensing finger 516 senses the tab 106, the sensing finger 516 causes a locking finger 518 to stop 1206 further movement of the dispensing lever 504.

In FIG. 13, a label dispensing method according to another example of the present invention is shown. The method includes the step of engaging a motion limiting mechanism 1100 with the locking finger 518, the motion limiting mechanism 1100 allowing 1306 a predetermined amount of extra movement of the dispensing lever 504 to occur, once engaged, before stopping 1308 further movement of the dispensing lever 504.

In describing examples and exemplary embodiments, specific terminology is employed for the sake of clarity in this disclosure. However, the disclosure of this patent specification is not intended to be limited to the specific terminology so selected and it is to be understood that each specific element includes all technical equivalents that operate in a similar manner.

In addition, the embodiments and examples above are illustrative, and many variations can be introduced on them without departing from the spirit of the disclosure or from the scope of the appended claims. For example, elements and/or features of different illustrative and exemplary embodiments herein may be combined with each other and/or substituted for each other within the scope of this disclosure.

What is claimed is:

1. A label comprising: a substrate and an adhesive layer, the label being releasably adhered to a backing material, and at least a portion of the label extending outwardly beyond a longitudinal edge of the backing material such that the portion of the label may be used to sense a position of the label.

2. A label according to claim 1, wherein the label has a leading edge and the portion of the label extending outwardly beyond the longitudinal edge of the backing material is spaced rearwardly of the leading edge of the label.

3. A dispensing apparatus for labels or the like comprising
a housing defining an application area for the labels;
a dispensing lever connected to the housing;
an advancing member connected to the dispensing lever; and
a locking mechanism, the locking mechanism comprising a sensing member and a locking member,
wherein the dispensing apparatus receives a label releasably adhered to a backing material wherein at least a portion of the label extends beyond a longitudinal edge of the backing material such that the sensing member senses the portion of the label,
the advancing member moves the backing material past the application area in response to a movement of the dispensing lever, such that the label is separated from the backing material, and
the locking member prevents further motion of the advancing member in a direction away from the application area when the sensing member senses that the portion of the label reaches a predetermined position relative to the application area.

4. The dispensing apparatus of claim 3, further comprising a motion transmission mechanism which transmits a displacement of the dispensing lever to cause a displacement of the advancing member.

5. The dispensing apparatus of claim 3, further comprising a biasing member for providing a resistive force opposing a motion of the dispensing lever which causes a movement of the advancing member away from the application area.

6. The dispensing apparatus of claim 3, wherein the sensing member senses that the portion of the label extending beyond the longitudinal edge of the backing material reaches the predetermined position relative to the application area by contacting the portion of the label.

7. The dispensing apparatus of claim 3, further comprising a label applicator adjacent to the application area and adjacent to a top surface of the label, wherein the label applicator contacts the top surface of the label once the label is partially separated from the backing material and presses the label against an object to which the label is applied.

8. A dispensing apparatus for labels or the like comprising
a housing defining an application area for the labels;
a dispensing lever connected to the housing;
an advancing member connected to the dispensing lever;
a locking mechanism, the locking mechanism comprising a sensing member and a locking member; and
a motion limiting mechanism engaged by the locking member when the sensing member senses that the portion of the label extending beyond the longitudinal edge of the backing material reaches a predetermined position relative to the application area,
wherein the dispensing apparatus receives a label releasably adhered to a backing material wherein at least a portion of the label extends beyond a longitudinal edge of the backing material such that the sensing member senses the portion of the label, and
the advancing member moves the backing material past the application area in response to a movement of the dispensing lever, such that the label is separated from the backing material.

9. The dispensing apparatus of claim 8, wherein
when the motion limiting mechanism is engaged by the locking member, the motion limiting mechanism allows the advancing member to move the backing material away from the application area by a predetermined extra distance before stopping further movement of the advancing member in the direction away from the application area.

10. A method for dispensing a label or the like from a dispensing apparatus, comprising the steps of:
advancing a label releasably adhered to a backing material towards an application area of the dispensing apparatus;
providing at least a portion of the label extending beyond a longitudinal edge of the backing material;
moving the backing material over the application area to separate the label from the backing material;
sensing when the portion of the label extending beyond the longitudinal edge of the backing material reaches a predetermined position relative to the application area; and
stopping further advancement of the label in the dispensing apparatus when the sensing step senses that the portion of the label reaches the predetermined position.

11. The method of claim 10, further comprising the step of allowing the label to be advanced an extra distance when the sensing step senses that the portion of the label reaches the predetermined position relative to the application area before stopping further advancement of the label in the dispensing apparatus.
